(19) United States
(12) Patent Application Publication
(10) Pub. No.: US 2026/0208412 A1
(43) Pub. Date: Jul. 23, 2026

(54) SOLVENT-PROTECTED PLASTIC PACKAGING FUSED WITH A MULTI-LAYER INNER COATING, ITS PRODUCTION PROCESS AND THE USE OF THE INNER COATING AS A SOLVENT PROTECTION AGENT

(71) Applicant: ROG TECHNOLOGIES, General Escobedo (MX)

(72) Inventors: Agustin Enrique GONZÁLEZ LEAL, San Nicolas De los Garza (MX); Julio Cesar RODRIGUEZ VILLA, General Escobedo (MX)

(73) Assignee: ROG TECHNOLOGIES, General Escobedo (MX)

(21) Appl. No.: 19/424,587

(22) Filed: Dec. 18, 2025

(30) Foreign Application Priority Data
Dec. 18, 2024 (MX) MX/A/2024/016142

(51) Int. Cl. B29C 45/14; B29C 45/00; B29K 623/00; B29K 677/00; B29L 31/00; B29L 31/56

(52) U.S. Cl. CPC B29C 45/14598; B29C 45/0001; B29C 45/0055; B29C 45/14065; B29C 2045/0079; B29C 2045/14319; B29K 2623/086; B29K 2677/00; B29K 2995/0058; B29K 2995/0097; B29L 2031/565; B29L 2031/712

(57) ABSTRACT

A plastic container coated (fused) on its inner surface with an extruded film; this film provides the resistance for this container to handle, store, contain, and maintain solvent-based liquids or semi-liquids without affecting or altering their chemical composition, replacing the metal container that is normally used for these products. The plastic container with adequate resistance to prevent said plastic container from deforming, softening, or suffering any effect due to the type of solvent-based liquid it contains. The process for obtaining said container and the use of the inner coating as a solvent protection agent. The plastic container is fused with the protective film or inner multilayer coating resistant to solvent-based products, both parts being fused without being able to be detached from one another.

### FIELD OF THE INVENTION

The object of the present invention is to provide a plastic container that is coated (fused) on its inner surface with an extruded film that provides the resistance to use this container with liquid or semi-liquid solvent-based products, replacing the metal container that is normally used for these products, since it prevents the plastic container from deforming or being damaged by the type of solvent-based liquid it contains. Likewise, the present invention provides the process for obtaining said container and the use of the inner coating as a solvent protection agent.

### BACKGROUND

Industries usually use chemical products to carry out their activities. It is essential to take into account the conditions under which these chemical products are stored in industrial facilities and the way they are handled in storage areas, in order to avoid accidents. Therefore, the material of the container used to store the chemical substances depends on the type of substance to be stored. There are different materials used in containers for chemical products: metal, plastic, and glass. Contyquim. (2020 Sep. 28). Containers for chemicals: Are there different kinds? Contyquim. https://contyquim.com/blog/contenedores-para-quimicos-hay-distintos.

Metal is the safest and most widely used material in industry. Steel and aluminum drums of up to 200 liters are used. For plastic containers, the most commonly used material is polyethylene, followed by polyvinyl chloride and polypropylene, due to their resistance to different types of chemical substances. However, it is not recommended to use them for more than 4 years. They have capacities starting at 0.25 liters and include a decompression opening to facilitate the release of the chemical. They are not used to store flammable products. Finally, although glass is resistant to most chemical substances, it is a fragile material and is used mainly to store small quantities of chemicals. Contyquim. (2020 Sep. 28). Containers for chemicals: Are there different kinds? Contyquim. https://contyquim.com/blog/contenedores-para-quimicos-hay-distintos.

Additionally, at present, the use of plastic containers in industry is limited by the chemical properties of the substances they store. Solvents, for example, tend to deteriorate common polymers such as polyethylene and polypropylene, causing deformations, structural weakening, or leaks. This forces companies to opt for more resistant materials, such as metal, although this increases production and logistics costs due to their weight and the additional processes required for maintenance and corrosion protection.

The industrial market is demanding alternatives that combine the chemical resistance of metals with the lightness, flexibility, and low cost of plastic. This has led to the search for innovations in coatings and treatments that strengthen polymers without compromising their functionality. Advances in extrusion technology and in the development of chemical compounds make it possible to manufacture specialized coatings that significantly improve the properties of plastic, making it suitable for containing more aggressive chemicals without deforming or deteriorating.

In addition, increasing environmental regulation and sustainable initiatives are driving industries to reduce the use of metal containers due to their environmental impact and the costs associated with recycling or final disposal. Plastic containers, when protected with suitable coatings, can be reused and recycled multiple times, representing a more economical and ecological solution compared to single-use metal containers or those with costly anticorrosive coatings.

On the other hand, sectors such as pharmaceuticals, cosmetics, and cleaning products face similar challenges, since their products often include solvents in their composition. The use of plastic containers coated with advanced materials not only allows for better chemical compatibility, but also reduces the risks of cross-contamination, which results in a competitive advantage for companies that adopt this technology.

With respect to the prior state of the art, in terms of inventions, there is U.S. document number US1986842600A which details a multilayer film comprising a central layer of ethylene-vinyl alcohol copolymer; two outer layers of (mixture of) polymeric materials; two inner layers of an adhesive comprising an anhydride (acid)-modified polyolefin; and two polyamide layers each of which adheres to opposite surfaces of the central layer. The foregoing provides good clarity, toughness and superior abrasion resistance, and can also be coextruded and fully oriented to provide a shrink film with good oxygen barrier properties and heat sealability, and can be heat sealed at relatively low temperatures.

Mexican invention corresponding to number PA/a/2000/003372 describes a multi-layer container for product distribution that includes a relatively rigid outer body and a relatively flexible inner liner to support the product to be distributed. The relatively rigid outer body includes, and preferably consists essentially of, an outer layer of virgin polyethylene such as HDPE, and a thicker inner layer that includes ground polyethylene. The relatively flexible inner layer includes, and preferably consists essentially of, an outer laminated layer adjacent to the inner layer of the body and composed of nylon, nylon blends or EVOH, an inner layer of polyethylene such as LLDPE, and an adhesive securing the inner and outer layers of the liner. The relatively thin outer HDPE layer in the plastic body provides the desired appearance, while the thicker inner layer provides structural rigidity using ground plastic. The outer liner layer of nylon, nylon blends or EVOH provides improved barrier properties against permeation of water, gases and flavorings, while the inner LLDPE layer provides improved primary flexibility and burst resistance, as well as moisture qualities as an additional barrier.

Mexican document number PA/a/2004/010715 provides a barrier laminated packaging material comprising, from its outermost surface toward its innermost surface in contact with the container content to be prepared therefrom, a first outer layer of a low-density polyethylene polymer, a paperboard substrate, a first laminated inner coating of nylon layer with a bonding resin layer, a blown film layer comprising a first layer of low-density polyethylene polymer, a bonding layer, a first inner layer of EVOH, a second bonding layer, a second inner layer of EVOH, a third bonding layer and a second inner layer of low-density polyethylene polymer, and the innermost layer in contact with the product.

The container for a chemical product described in U.S. document number US20070178266A1 has a multilayer wall including at least one structural layer comprising a non-fluorinated polyolefin and a barrier layer of ethylene-vinyl alcohol copolymer or polyamide. In addition, the wall is crosslinked, for example, by exposure to electron-beam radiation.

U.S. Pat. No. 7,335,409B2 relates to a method of manufacturing a heat-sealable packaging material, to a polymer-coated packaging material manufactured using the method, and to a sealed package to be manufactured from the material. The packaging material comprises a fiber base, such as a packaging board, and an inner water vapor barrier layer extruded on both sides, containing high-density polyethylene (HDPE), and an outer heat-seal layer, the material of which is, for example, low-density polyethylene (LDPE). In addition, oxygen barrier polymer layers can be incorporated into the packaging material, the material of the oxygen barrier layers being, for example, ethylene-vinyl alcohol copolymer (EVOH) or polyamide (PA). With the HDPE layer, the permeation of water vapor is prevented in both directions, and the placement of the extruded layers on both sides of the fiber base reduces curling of the material.

Document number U.S. Pat. No. 9,193,509B2 relates to a double-barrier laminated structure, particularly suitable for aggressive or moisture-containing products. It also relates to a plastic-based laminate (PBL) or an aluminum-based laminate (ABL) comprising said double-barrier laminate.

Patent application MX/a/2016/008074 describes liners for bulk material containers such as rigid intermediate bulk containers (IBC) that are abuse-resistant and provide barriers. The liners have at least one side wall that is multilayer, and the layers are multistructured. The liners are preferably metal-free. Each of the layers independently comprises at least three strata comprising: a first stratum and a third stratum, each comprising a linear low-density polyethylene (LLDPE) or an ultra-low-density polyethylene (VLDPE); and a second stratum between the first and third strata and comprising a thermoplastic oxygen barrier of ethylene-vinyl alcohol copolymer (EVOH) and a thermoplastic elastomer (TPE). A layer may further comprise a fourth stratum and a fifth stratum, each comprising a polyamide, with the fourth stratum located between the first and second strata, and the fifth stratum located between the second and third strata. Methods of making and using the liners are also provided.

Invention number US20180272666A1 describes a coating for containers or packages.

The coating includes several polymer layers, exhibits a barrier function (for example, barrier function against gases or moisture), and can be peelably bonded to one or more container/package surfaces. When the coating coats a package or container, the package or container exhibits the barrier function of the coating, and the coating can be peeled from the package or container to facilitate recycling or disposal. The coating is thermoformable and can therefore be shaped to fit the shape of a preformed container or shaped simultaneously with the formation of the container from a precursor material to which the coating is peelably bonded, either before or during formation of the container.

Finally, document number CN202210693914A provides a film material for a disposable bioprocess bag of multilayer coextrusion and a method of preparation and application thereof, in which a gas barrier layer is prepared by adopting a three-layer composite structure of nylon/ethylene-vinyl alcohol copolymer/nylon or ethylene-vinyl alcohol copolymer/nylon/ethylene-vinyl alcohol copolymer, ULDPE is used as the liquid-contact layer, and an optimal heat-seal layer, an optimal adhesive layer and an appropriate thickness are selected, so that the prepared disposable bioprocess bag has good gas barrier property, water resistance, strength, bending resistance, puncture resistance, excellent heat-seal property and transparency, good biocompatibility, among others.

### BRIEF DESCRIPTION OF THE FIGURES

FIG. 1. Shows a drawing of a plastic container fused with an inner multilayer protective film against solvents.

FIG. 2. Shows the process of the present invention.

FIG. 3. Shows the distribution of layers of the extruded multilayer protective film.

FIG. 4. Shows a top isometric view of the final container, which is the object of the present invention.

FIG. 5. Shows a side view of the final container, which is the object of the present invention.

FIG. 6. Shows a detailed view of a portion of the final container, which is the object of the present invention.

FIG. 7. Shows a detailed view of a portion of the final container, which is the object of the present invention.

FIG. 8. Shows a detailed view of a portion of the final container, which is the object of the present invention.

FIG. 9. Shows a photograph illustrating the container used before the 240 h test in an oven at 60° C.

FIG. 10. Shows a photograph illustrating the container used after the 240 h test in an oven at 60° C.

FIG. 11. Shows a photograph illustrating the inside of the container used after the 240 h test in an oven at 60° C., showing the detachment of the coating.

FIG. 12. Shows a photograph illustrating the inside of the container used before the 2,000 h test in an oven at 60° C.

FIG. 13. Shows a photograph illustrating the outside of the container used before the 2,000 h test in an oven at 60° C.

FIG. 14. Shows a photograph illustrating the inside of the container used after the 2,000 h test in an oven at 60° C.

FIG. 15. Shows a photograph illustrating the outside of the container used after the 2,000 h test in an oven at 60° C.

FIG. 16A shows the containers used before the 90-day test at room temperature at day zero with coating.

FIG. 16B shows the containers used before the 90-day test at room temperature at day zero without coating.

FIG. 16C shows the containers used before the 90-day test at room temperature at day 90 with coating.

FIG. 16D shows the containers used before the 90-day test at room temperature at day 90 without coating.

### DETAILED DESCRIPTION OF THE INVENTION

The present invention provides a plastic container fused with an extruded protective multilayer inner coating, its production process, and the use of the inner coating as a solvent-protective agent. The container comprises on its inner surface a structure formed by layers of polyethylene, nylon, and EVOH; in the following order Polyethylene-Nylon-EVOH-Nylon-Polyethylene, the % of each of these components being shown in Table 1:

TABLE 1
Detail of the layers that make up the multilayer inner
coating that acts as a solvent-protection agent. Where
the tolerance range is −2%/+4% for each layer.

| MATERIAL | Gauge | Microns | % |
|---|---|---|---|
| PE | 56 | 14.2 | 14.0% |
| PE | 60 | 15.2 | 15.0% |
| Adhesive (tie | 32 | 8.1 | 8.0% |
| layer) | | | |
| NYLON | 36 | 9.1 | 9.0% |
| EVOH | 32 | 8.1 | 8.0% |
| NYLON | 36 | 9.1 | 9.0% |
| Adhesive (tie | 32 | 8.1 | 8.0% |
| layer) | | | |
| PE | 60 | 15.2 | 15.0% |
| PE | 56 | 14.2 | 14.0% |

Process for Obtaining the Solvent-Protected Plastic Container Fused with a Multilayer Inner Coating

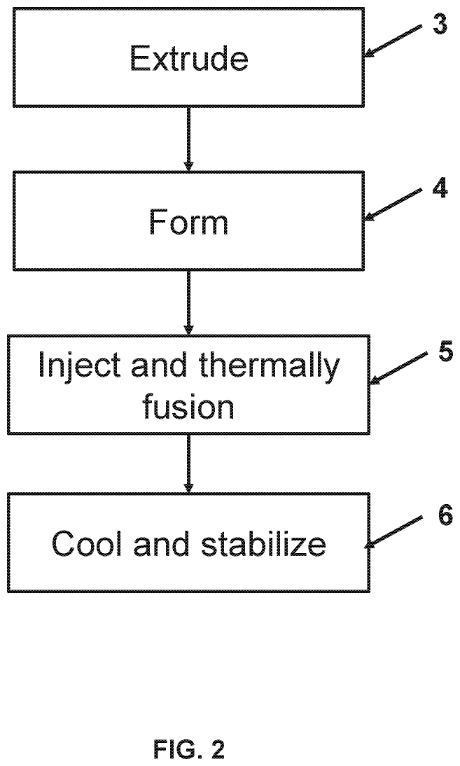

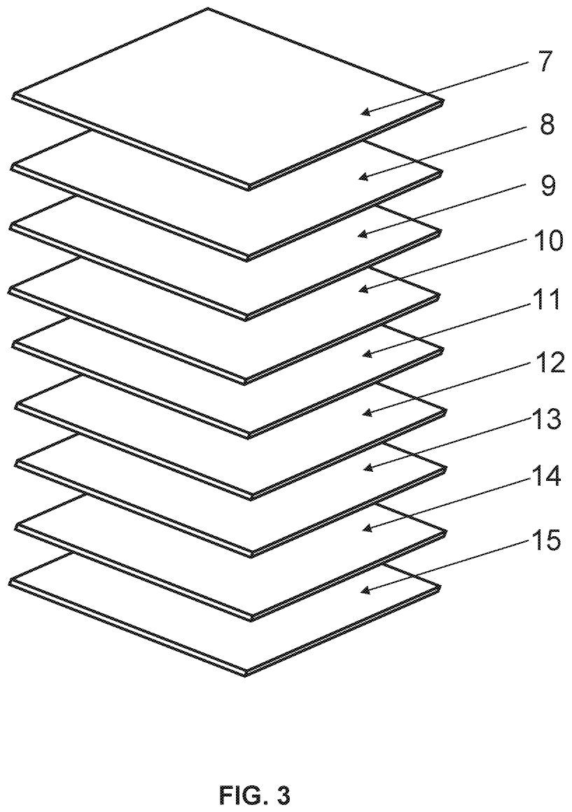

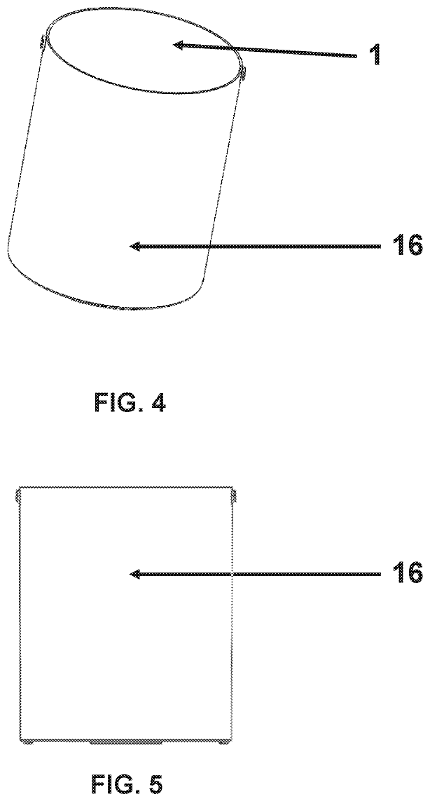

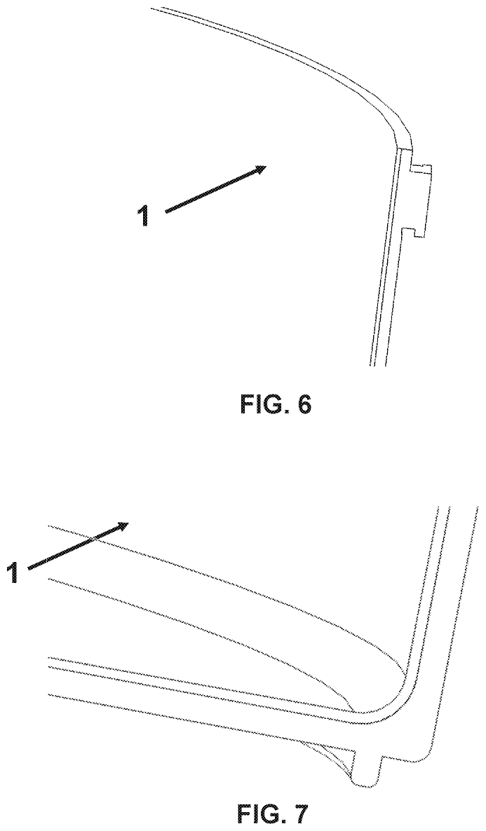

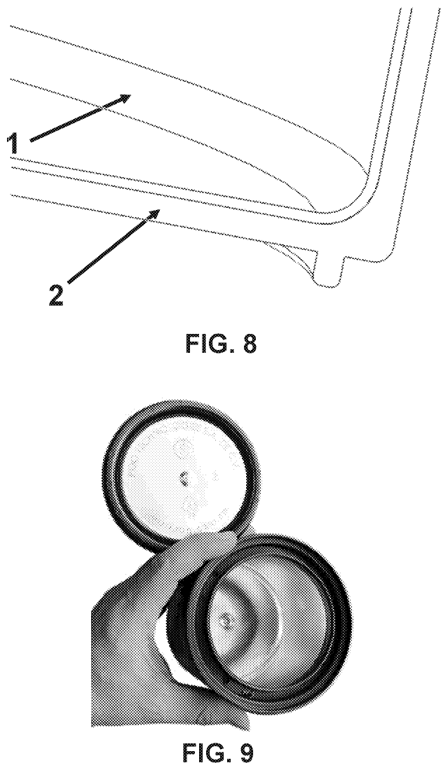

The process of the present invention, as shown in FIG. 2, comprises the steps of: a) Extruding a multilayer film for chemical protection, b) Forming preforms from the multilayer film extruded in step a) to obtain preforms with protective coating, c) Injecting and thermally fusing at a temperature of 180° C. to 240° C. the container and the preforms with protective coating obtained in step b) to obtain a container, d) Cooling and stabilizing at a temperature between 10° C. and 40° C. the container obtained in step c) to obtain a plastic container with solvent protection fused with a multilayer inner coating, which are detailed below:
a) Extruding a multilayer film for chemical protection (3)

In this step a multilayer film (1) is produced, designed to act as a protective barrier against solvents. The film has a thickness of 100 microns, a total gauge of 400 gauges and a tolerance range of +10% over the nominal thickness of 101.6 microns. The multilayer film comprises the elements detailed below in the following order: Polyethylene-Nylon-EVOH-Nylon-Polyethylene, wherein said film comprises 14% of a first layer of Polyethylene (7), 15% of a second layer of polyethylene (8), 8% of a first adhesive layer (9), 9% of a first Nylon layer (10), 8% of EVOH (11), 9% of a second Nylon layer (12), 8% of a second adhesive layer (13), 15% of a third Polyethylene layer (14) and 14% of a fourth Polyethylene layer (15), as shown in FIG. 3, wherein the film comprises the detailed structure and elements shown in Table 1, where the preferred percentages are found.
b) Forming preforms from the multilayer film extruded in step a) to obtain preforms with protective coating (4).

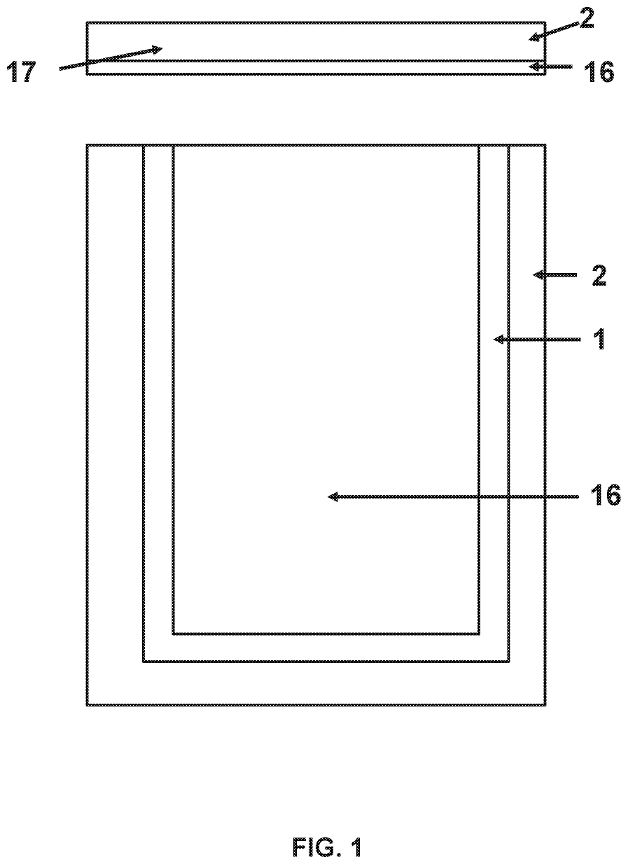

The multilayer film (1) obtained in step a) is cut according to the required dimensions according to the container to be formed, wherein the container consists of a vessel (16) provided with a cap on its upper part (17), as shown in FIG. 1, and is positioned inside a mold for a plastic container, as seen in FIG. 1, said mold being previously temperature-conditioned at a controlled temperature of 10° C. to 40° C. This step ensures the adequate fit of the film in the inner contour of the mold. Said preforms must cover from 95 to 100% of the interior of the container that will be formed by the mold. In this step, it is important to place the preforms inside the mold according to the area to be coated.
c) Injecting and thermally fusing at a temperature of 180° C. to 240° C. the container and the preforms with protective coating obtained in step b) to obtain a container (5)

In this step, the plastic material is melted (2) and introduced into the mold that contains the preforms with protective coating (1). The temperature of the molten plastic is kept between 180° C. and 240° C., while the mold is hermetically closed to ensure uniform contact between the preforms with protective coating and the molten plastic material. The preforms with protective coating (1) are at a controlled temperature of 10° C. to 40° C., which allows complete fusion with the molten plastic material (2). At the end, a container is obtained with a thickness of 1 to 4 mm, wherein 0.08 to 0.15 mm correspond to the inner coating.
d) Cooling and stabilizing at a temperature of 10° C. to 40° C. the container obtained in step c) to obtain a solvent-protection container (6)

The process is carried out in an environment with a controlled temperature of 10° C. to 40° C., to ensure the quality and stability of the container. Once the molten plastic material has cooled and solidified, a plastic container with a multilayer film (1) fully adhered or fused on its inner surface is removed from the mold, providing effective solvent protection. At the end of this step, a plastic container with solvent protection fused with a multilayer inner coating is obtained.

### Example 1. Preferred Process to Obtain a Container with Coating for Solvents

To begin, the solvent-protective multilayer film (1) is obtained with a thickness of 100 microns, with a total gauge of 400 gauge and 101.6 microns; and having a tolerance range of 101.6±10%, following the formulation found in Table 1.

Subsequently, the shapes or preforms of the protective film or coating are cut to size and positioned inside the container mold, previously temperature-conditioned in a range of 10° C. to 40° C. Next, an overmolding process is carried out, introducing the molten base plastic (2) at a temperature between 180° C. to 240° C. The mold, which contains inside it the solvent-protective multilayer film (1) at a temperature of 10° C. to 40° C., is hermetically closed. The hot molten plastic material (2), with a temperature of 180° C. to 240° C., comes into contact with the solvent-protective multilayer film (1), generating complete fusion between both materials. It is important to note that the process is carried out in an environment with a controlled temperature of 10° C. to 40° C., which is essential to ensure the quality and integrity of the final product.

Finally, as shown in FIG. 1, a plastic container is obtained that is coated on its inner surface with a solvent-protective multilayer film (1) with a thickness of 0.1 mm (Tolerance −0.02+0.05) range of 0.08 to 0.15 mm and the container with a total thickness in the range of 1 mm to 4 mm.

### Example 2: Resistance Test

Test with multilayer coating thickness 50 microns+metallized BOPP of thickness 15 microns.

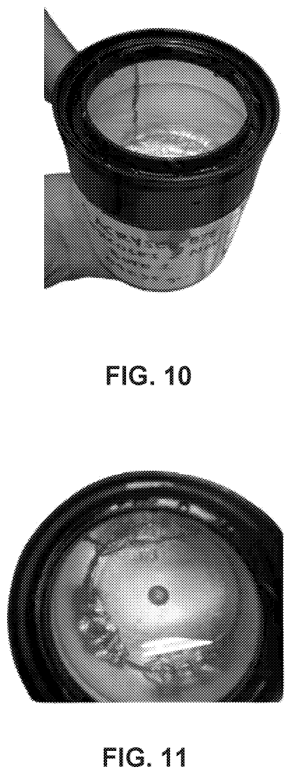

In FIG. 9 the container before the test is shown, with an initial weight of 956 g (0.05 mm PE+PE+NY+EVOH+NY+PE+PE+0.015 mm metallized BOPP) and in FIG. 10 the container after 240 hours in an oven at 60° C. with Acrycel Doal® paint is shown; FIG. 11 shows that in its appearance there is a detachment of the metallized BOPP, where the final weight remains at 956 g, its exterior appearance is maintained, it presents no deformations nor migration of odors to the exterior.

Test with multilayer coating with a thickness of 50 microns.

When a test was carried out with a 0.05 mm coating of PE+PE+NY+EVOH+NY+PE+PE, the material could not be handled, since it was very thin and flexible, so samples could not be prepared for evaluation.

Test with multilayer coating with a thickness of 100 microns.

(0.10 mm PE+PE+NY+EVOH+NY+PE+PE) A laboratory test was carried out where the container with solvent-based product inside was left for 2,000 hours inside an oven at 60 degrees Celsius. At the end of the test, there were no deformations in the container, nor bubbles inside it, nor migration of the solvent to the exterior, nor detachment of the coating.

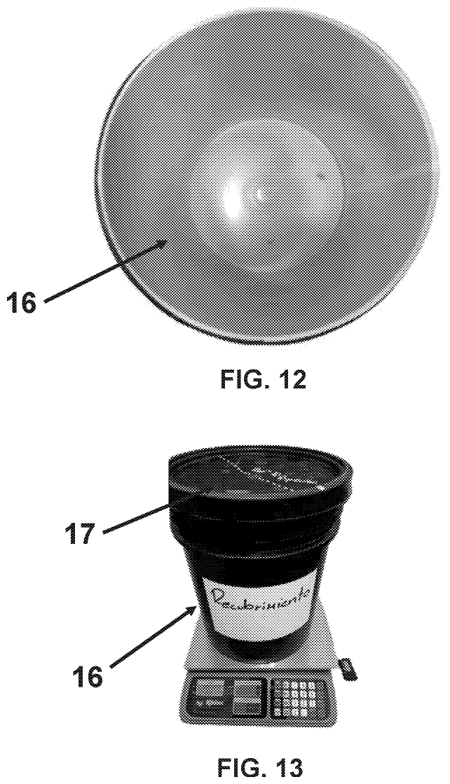

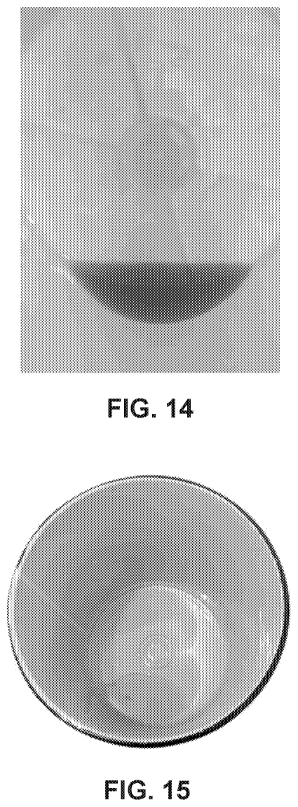

In FIG. 12 and FIG. 13 evidence of the container before the 2,000-hour test is shown, with an initial weight of 19.07 kg, and in FIGS. 14 and 15 the container after 2,000 hours in an oven at 60° C. with solvent-based paint Acrycel Doal® is shown, where the final weight is maintained, its final external appearance remains intact, showing no deformations, nor migration of odors to the outside of the container, the same being true of its inner appearance. It is important to mention that the test was repeated with different types of solvent-based paint obtaining the same results, paints such as: Suma Berel®, Wherever® varnish and Sayer® varnish.

### Example 3. Aging Test in Oven

Aging tests were carried out in an oven at 60° C. for 3 months; at the end of the test, no deformations or cracks were present in the container, nor loss of weight of container+liquid, and no odor on the outside of the closed container for the finished containers. No detachments of the inner protective coating were present either.

### Example 4. 90-Day Test at Room Temperature

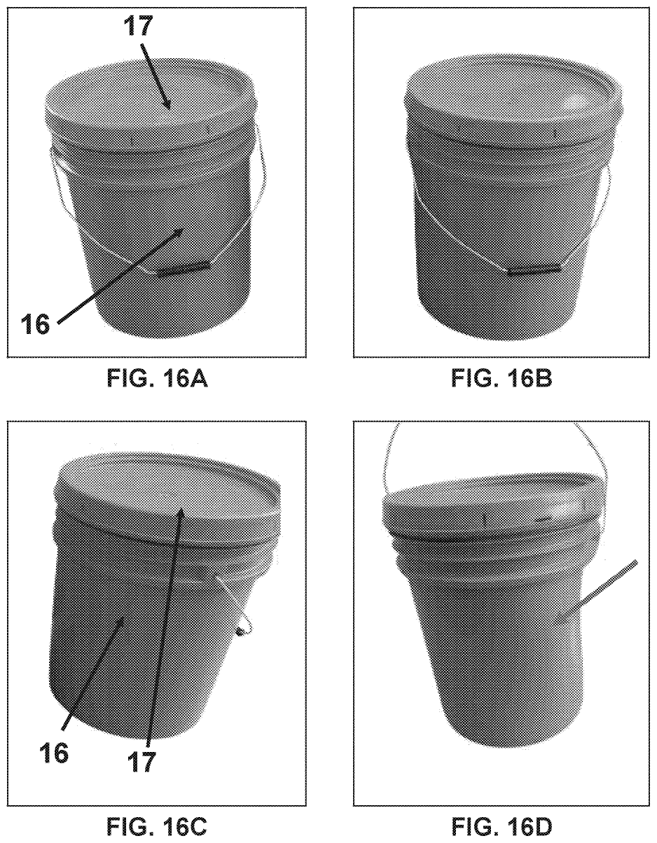

A test was carried out with solvents inside, where containers with the coating that is the object of the present invention A) of FIG. 16, and without coating B) of FIG. 16 were tested; 90 days later it was observed that the container with coating maintains its structure C) of FIG. 16, while the container without coating shows a collapsed structure D) of FIG. 16.

Having sufficiently described my invention, I consider as novel and therefore claim as my exclusive property what is contained in the following claims:

1. A process for obtaining a container with an extruded solvent-protection coating comprising the steps of:
a) extruding a multilayer film for chemical protection;
b) forming preforms from the multilayer film extruded in step a) to obtain preforms with protective coating;
c) injecting and thermally fusing at a temperature of 180° C. to 240° C. the container and the preforms with protective coating obtained in step b) to obtain a container;
d) cooling and stabilizing at a temperature of 10° C. to 40° C. the container obtained in step c) to obtain a solvent-protection container, which are detailed below.

2. The process for obtaining a container with an extruded solvent-protection coating, according to claim 1, wherein in the step a) a multilayer film (1) is produced with a thickness of 100 microns, a total gauge of 400 gauge and a tolerance range of ±10% over the nominal thickness of 101.6 microns, said multilayer film comprising 14% of a first layer of Polyethylene (7), 15% of a second layer of polyethylene (8), 8% of a first adhesive layer (9), 9% of a first Nylon layer (10), 8% of EVOH (11), 9% of a second Nylon layer (12), 8% of a second adhesive layer (13), 15% of a third Polyethylene layer (14) and 14% of a fourth Polyethylene layer (15), wherein the % range of each layer is −2%/+4%.

3. The process for obtaining a container with an extruded solvent-protection coating, according to claim 1, wherein in step b) the multilayer film (1) obtained in step a) is cut into preforms according to the required dimensions according to the container to be formed, and is positioned inside a mold for a plastic container, said mold being previously temperature-conditioned at a controlled temperature of 10° C. to 40° C., ensuring the adequate fit of the film in the inner contour of the mold.

4. The process for obtaining a container with an extruded solvent-protection coating, according to claim 1, wherein in that in step c) a formulation of molten base plastic (2) is introduced into the mold that contains the preforms with protective coating (1); the temperature of the molten plastic is kept between 180° C. and 240° C., while the mold is hermetically closed to ensure uniform contact between the preforms with protective coating and the molten plastic material; the preforms with protective coating (1) are at a controlled temperature of 10° C. to 40° C. to obtain a container with a thickness of 1 to 4 mm, wherein 0.08 to 0.15 mm correspond to the protective multilayer film.

5. The process for obtaining a container with an extruded solvent-protection coating, according to claim 1, wherein in step d) it is carried out in an environment with a controlled temperature of 10° C. to 40° C., once the molten material has cooled and solidified, a plastic container with solvent protection fused with a multilayer inner coating is obtained.

6. The process for obtaining a container with an extruded solvent-protection coating according to claim 3, wherein the container includes a vessel (16) provided with a cap on an upper part (17).

7. The process for obtaining a container with an extruded solvent-protection coating, according to claim 3, wherein said preforms must cover from 95 to 100% of the interior of the container that will be formed by the mold.

8. A plastic container with an extruded solvent-protection coating according to claim 1, wherein said extruded solvent-protection coating comprises 14% of a first layer of Polyethylene (7), 15% of a second layer of polyethylene (8), 8% of a first adhesive layer (9), 9% of a first Nylon layer (10), 8% of EVOH (11), 9% of a second Nylon layer (12), 8% of a second adhesive layer (13), 15% of a third Polyethylene layer (14) and 14% of a fourth Polyethylene layer (15), wherein the % range of each layer is −2%/+4%.

9. The container with an extruded solvent-protection coating, according to claim 8, wherein the container has a thickness of 1 to 4 mm, wherein 0.08 to 0.15 mm correspond to the fused film.

10. An inner coating for plastic containers comprising 14% of a first layer of Polyethylene (7), 15% of a second layer of polyethylene (8), 8% of a first adhesive layer (9), 9% of a first Nylon layer (10), 8% of EVOH (11), 9% of a second Nylon layer (12), 8% of a second adhesive layer (13), 15% of a third Polyethylene layer (14) and 14% of a fourth Polyethylene layer (15) to be used as a solvent protection agent.
